(19) United States
(12) Patent Application Publication
(10) Pub. No.: US 2013/0225232 A1
(43) Pub. Date: Aug. 29, 2013

(54) AIRCARD BOOSTER DEVICE

(71) Applicant: Shelia Hall, Ashland, KY (US)

(72) Inventor: Shelia Hall, Ashland, KY (US)

(21) Appl. No.: 13/405,194

(22) Filed: Feb. 24, 2012

(51) Int. Cl. H04W 88/06

(52) U.S. Cl. 455/552.1

(57) ABSTRACT

The present invention is an air card booster device with a proximal end and a distal end that secures an air card and provides additional and enhanced wireless communications capability to the air card and includes a stopper disposed on the proximal end of the device, a clip disposed on the distal end of the device and accommodates, wraps around and secures the air card and a signal amplifier that provides the Wi-Fi enhanced wireless capability to the air card. The device can be made of durable plastic or metal and the air card is an air stick or a USB memory stick. The device can also be inserted into a wireless phone or a wireless computer.

### TECHNICAL FIELD & BACKGROUND

Currently there are limited options in portable cellular accessories that promote Wi-Fi strength in challenging areas. In this age of technology, individuals are always interested in mediums that will ensure speedy wireless access regardless of one's geographical location.

The present invention generally relates to a booster device. More specifically, the invention is an air card booster device.

It is an object of the invention to provide an air card booster device that serves as an accelerating communications device.

It is an object of the invention to provide an air card booster device that is adjustable to accommodate a plurality of different air card dimensions and sizes.

It is an object of the invention to provide an air card booster device that provides additional and enhanced capability to an air card in a relatively remote area.

What is really needed is an air card booster device that serves as an accelerating communications device that is adjustable to accommodate a plurality of different air card dimensions and sizes that provides additional and enhanced capability to an air card in a relatively remote area.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of an air card booster device that is fit around an air card, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

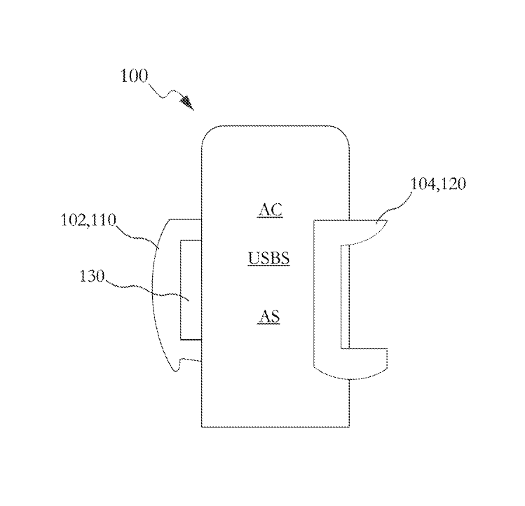

FIG. 1 illustrates a side view of an air card booster device 100 that is fit around an air card AC, according to an embodiment of the present invention. The air card booster device 100 serves as an accelerating communications device that is adjustable to accommodate a plurality of different air card AC dimensions and sizes that typically provides additional and enhanced capability to a wireless air card AC in a relatively remote area, for enhanced Wi-Fi use or other suitable area.

The air card booster device 100 has a proximal end 102 and a distal end 104 and includes a stopper 110, a clip 120 and a signal amplifier 130. The stopper 110 is disposed on the proximal end 102 of the air card booster device 100. The clip 120 is disposed on the distal end 104 of the air card booster device 100 and accommodates, secures and wraps around the air card AC and adjustably applies pressure to the air card AC to press the air card AC against the stopper 110 securing the air card AC in place. The signal amplifier 130 enhances the signal from the air card AC and can be disposed or encased anywhere on the air card booster device 100

The air card booster device 100 can be utilized to accelerate communication and enhance an air stick AS, USB memory stick USBS or other suitable air card AC. Specifically, the air card booster device 100 is a relatively lightweight and compact signal amplifier 110 to better communicate and maintain computing access points in wireless communications that are typically Wi-Fi communications but can be used for other suitable types of communications as well. The air card booster device 100 can be inserted into a specific phone and/or computer port and allows for increased air coverage and makes it relatively easier to engage and conduct relatively long conversations or computer usage without concern of a relatively weak signal or reoccurrence of dropped calls. The air card booster device 100 is adjustable and can be aesthetically decorated in a wide variety of colors and designs.

The air card booster device is a lightweight signal amplifier, introduces an alternative to maintaining computing access points. Made of modern components such as durable metal or plastic, the adjustable booster and air card, once inserted into a specific wireless phone and/or computer port, allows for increased air coverage. The user is immediately able to make and receive phone calls as well as engage in long conversations without concern of weak signals or the reoccurrence of dropped calls. The air card booster device can be marketed in various colors and styles to appeal to diverse consumers tastes.

The air card booster device is a one-size-fits-all accessory that can work for a plurality of different types of multiple wireless devices such as wireless cell phones, computers or other suitable devices. The feature of signal supporting compact air card booster, which could be marketed as a rugged version with camouflage designs to aide military use, can also become an essential medium for avid cellphone carriers.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. An air card booster device with a proximal end and a distal end that secures an air card and provides additional and enhanced wireless communications capability to said air card, comprising:
a stopper disposed on said proximal end of said device;
a clip disposed on said distal end of said device and accommodates and secures said air card; and
a signal amplifier that provides said enhanced wireless capability to said air card.

2. The device according to claim 1, wherein said clip and adjustably applies pressure to said air card AC to press said air card AC against said stopper securing said air card in place.

3. The device according to claim 1, wherein said signal amplifier enhances a wireless signal from said air card and is disposed or encased within said air card booster device.

4. The device according to claim 1, wherein said signal amplifier better communicates and maintains computing one or more access points in one or more said wireless communications.

5. The device according to claim 4, wherein said wireless communications are Wi-Fi communications.

6. The device according to claim 1, wherein said air card is an air stick.

7. The device according to claim 1, wherein said air card is a USB memory stick.

8. The device according to claim 1, wherein said device is a made of durable metal.

9. The device according to claim 1, wherein said device is a made of durable plastic.

10. The device according to claim 1, wherein said device is inserted into a wireless phone.

11. The device according to claim 1, wherein said device is inserted into a wireless computer.

12. An air card booster device with a proximal end and a distal end that secures an air card and provides additional and enhanced wireless communications capability to said air card, comprising:
a stopper disposed on said proximal end of said device;
a clip disposed on said distal end of said device and accommodates, wraps around and secures said air card; and
a signal amplifier that provides said Wi-Fi enhanced wireless capability to said air card.

13. The device according to claim 12, wherein said clip and adjustably applies pressure to said air card AC to press said air card AC against said stopper securing said air card in place.

14. The device according to claim 12, wherein said signal amplifier enhances a wireless signal from said air card and is disposed or encased within said air card booster device.

15. The device according to claim 12, wherein said signal amplifier better communicates and maintains computing one or more access points in one or more said Wi-Fi wireless communications.

16. The device according to claim 12, wherein said air card is an air stick.

17. The device according to claim 12, wherein said air card is a USB memory stick.

18. The device according to claim 12, wherein said device is a made of durable metal.

19. The device according to claim 12, wherein said device is a made of durable plastic.

20. The device according to claim 12, wherein said device is inserted into a wireless phone or wireless computer.
